(19) United States
(12) Patent Application Publication
(10) Pub. No.: US 2014/0164230 A1
(43) Pub. Date: Jun. 12, 2014

(54) SYSTEMS, METHODS, AND COMPUTER PROGRAM PRODUCTS FOR A COLLECTION ON DELIVERY DELAYED DEPOSIT SERVICE

(71) Applicant: United Parcel Service of America, Inc., Atlanta, GA (US)

(72) Inventors: Robert L. Klingenberg, Atlanta, GA (US); Jonathan Terry, Glastonbury, CT (US)

(73) Assignee: United Parcel Service of America, Inc., Atlanta, GA (US)

(21) Appl. No.: 14/181,920

(22) Filed: Feb. 17, 2014

Related U.S. Application Data
(63) Continuation-in-part of application No. 13/947,269, filed on Jul. 22, 2013.
(60) Provisional application No. 61/673,841, filed on Jul. 20, 2012.

(51) Int. Cl. G06Q 20/22; G06Q 20/14

(52) U.S. Cl. CPC G06Q 20/22; G06Q 20/14
USPC 705/39

(57) ABSTRACT

Various embodiments provide systems for providing a delayed deposit collection on delivery (COD) option to a customer. The system may comprise one or more computer processors configured to: (a) receive a portion of payment data and package data; (b) receive an indication of a payment deposit parameter; (c) associate the payment deposit parameter with the payment data; (d) compare the payment deposit parameter to a default deposit parameter; (e) calculate a payment deposit date based at least in part on the comparison and at least a portion of the package data comprising delivery data; (f) facilitate depositing the payment mechanism on the calculated payment deposit date; and (g) automatically re-present the payment mechanism if an error occurs during the depositing of the payment mechanism. Associated computer program products and computer-implemented methods are also provided.

### CROSS-REFERENCE TO RELATED APPLICATIONS

This application is a continuation-in-part of and claims the benefit of U.S. patent application Ser. No. 13/947,269, entitled “Systems, Methods, and Computer Program Products for a Collection on Delivery Delayed Deposit Service,” filed Jul. 22, 2013, which is a non-provisional filing of and claims priority to U.S. Provisional Application Ser. No. 61/673,841, filed Jul. 20, 2012, both of which are hereby incorporated herein in their entireties.

### BACKGROUND

Shipping carriers (e.g., common carriers, such as United Parcel Service, Inc. (UPS), FedEx, United States Postal Service (USPS), etc.) offer customers collection on delivery (COD) shipping options. Generally, the carrier receives a COD package from the customer, delivers the COD package to the receiver, and collects a COD payment check or other COD payment mechanism from the receiver. If the customer has an account with the carrier configured to accept direct deposits, the funds represented by the COD payment mechanism will be deposited into the customer's bank account. However, if the customer wishes to take advantage of the convenience of direct deposit of COD payments, the customer often times may not be able to control when the COD payment is deposited. If the customer does not have a direct deposit customer account with the carrier, the COD payment mechanism will be sent to the customer. Thus, the customer may choose when the COD payment is deposited; however, the customer must then further facilitate the deposit of the COD payment check. Thus, there exists a need for an improved COD shipping service that enables customer-customizable control of deposits of COD payment checks.

### BRIEF SUMMARY

Embodiments of the present invention provide collection on delivery (COD) customers with an option for delayed deposit of COD payment mechanisms. In various embodiments, a COD customer may ship a COD package via a carrier. The carrier delivers the package to the receiver and collects a COD payment mechanism. The COD customer may indicate a requested date for deposit or indicate a requested number of days for which deposit of the COD payment mechanism should be delayed. The funds represented by the COD payment mechanism are then deposited into COD customer's bank account on the requested deposit date or after the requested delay.

Various embodiments of the present invention provide systems for providing a delayed deposit COD option to a COD customer. In such embodiments, the system may comprise one or more storage areas containing customer profile data associated with the COD customer, payment data, package data associated with at least one COD package shipped by the COD customer, and parameter data. The parameter data may include a default deposit parameter associated with the COD customer. In various such embodiments, the system may further comprise one or more computer processors configured to (a) receive a portion of the payment data and the package data, wherein the portion of the payment data may include an electronic image of a COD payment mechanism; (b) receive an indication of a payment deposit parameter; (c) associate the payment deposit parameter with the payment data; (d) compare the payment deposit parameter to the default deposit parameter; (e) calculate a payment deposit date based at least in part on the comparison of the payment deposit parameter and the default deposit parameter and at least a portion of the package data, including delivery data; (f) in response to the calculation of the payment deposit date, facilitate depositing the COD payment mechanism on the calculated payment deposit date; and (g) in response to receiving notification of an error occurring during the depositing of the COD payment mechanism, automatically re-present the COD payment mechanism.

In other embodiments, of the present invention, a computer-implemented method for providing a delayed deposit COD option to a COD customer is provided. In such embodiments, the method comprises the steps of receiving and storing, within one or more storage areas, customer profile data associated with the COD customer, payment data, package data associated with at least one COD package shipped by the COD customer, and parameter data. The parameter data may include a default deposit parameter associated with the COD customer. The method may further comprise the steps of (a) receiving a portion of the payment data and the package data, the portion of the payment data comprising an electronic image of a COD payment mechanism; (b) receiving an indication of a payment deposit parameter; (c) associating the payment deposit parameter with the payment data; (d) comparing, via at least one computer processor, the payment deposit parameter to the default deposit parameter; (e) calculating, via at least one computer processor, a payment deposit date, the calculation being based at least in part on the comparison of the payment deposit parameter and the default deposit parameter and at least a portion of the package data including delivery data; (f) in response to the calculation of the payment deposit date, facilitating deposit of the COD payment mechanism on the calculated payment deposit date; and (g) in response to receiving notification of an error occurring during the depositing of the COD payment mechanism, automatically re-presenting the COD payment mechanism.

In still other embodiments, a computer program product is provided. In such embodiments, the computer program product comprises at least one computer-readable storage medium having computer-readable program code portions embodied therein. The computer-readable program portions may comprise an executable portion configured for (A) receiving a plurality of data. In such embodiments, the plurality of data may comprise: (i) customer profile data associated with a collection on delivery (COD) customer; (ii) payment data, wherein the payment data comprises an electronic image of a COD payment mechanism; (iii) package data associated with at least one COD package shipped by the COD customer; (iv) parameter data, wherein the parameter data comprises a default deposit parameter associated with the COD customer; and (v) an indication of a payment deposit parameter. In various embodiments, the computer-readable program portions may further comprise executable portions configured for: (B) comparing the payment deposit parameter to the default deposit parameter; (C) calculating a payment deposit date based at least in part on the comparison of the payment deposit parameter and the default deposit parameter and at least a portion of the package data including delivery data; (D) in response to calculating the payment deposit date, generating one or more instructions, the instructions configured to facilitate depositing the COD payment mechanism on the payment deposit date; and (E) an executable portion configured for, in response to receiving notification of an error occurring during the depositing of the COD payment mechanism, automatically re-present the COD payment mechanism.

### BRIEF DESCRIPTION OF THE SEVERAL VIEWS OF THE DRAWING(S)

The accompanying drawings incorporated herein and forming a part of the disclosure illustrate several aspects of the present invention and together with the detailed description serve to explain certain principles of the present invention. In the drawings, which are not necessarily drawn to scale:

FIG. 1 is a block diagram of a system architecture that may be used in conjunction with a delayed deposit COD option according to various embodiments;

FIG. 2 is schematic block diagram of a carrier system according to various embodiments;

FIG. 3 is a flow diagram illustrating the delayed deposit option registration process according to various embodiments;

FIG. 4 is a flow diagram illustrating the COD delivery process without the delayed deposit COD option;

FIG. 5 is a flow diagram illustrating the delayed deposit COD option process according to various embodiments;

FIG. 6 shows a screen shot of an exemplary summary window as may be provided via an exemplary website provided in conjunction with the system according to various embodiments; and

FIGS. 7A-7D show screen shots of exemplary screen displays of the system according to various embodiments.

### DETAILED DESCRIPTION

Various embodiments of the present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory, multimedia memory cards (MMC), secure digital (SD) memory cards, Memory Sticks, and/or the like. Further, a non-volatile computer-readable storage medium may also include conductive-bridging random access memory (CBRAM), phase-change random access memory (PRAM), ferroelectric random-access memory (FeRAM), resistive random-access memory (RRAM), Silicon-Oxide-Nitride-Oxide-Silicon memory (SONOS), racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Rambus in-line memory module (RIMM), dual in-line memory module (DIMM), single in-line memory module (SIMM), video random access memory (VRAM), cache memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations, respectively, may be implemented in the form of a computer program product, an entirely hardware embodiment, a combination of hardware and computer program products, and/or apparatus, systems, computing devices, computing entities, and/or the like carrying out instructions on a computer-readable storage medium for execution. Such embodiments can produce specifically-configured machines performing the steps or operations specified in the block diagrams and flowchart illustrations. Accordingly, the block diagrams and flowchart illustrations support various combinations of embodiments for performing the specified steps or operations.

### II. GENERAL OVERVIEW

The present invention is directed to providing a delayed deposit collection on delivery (COD) option to one or more COD customers. A COD customer may request to register to use the delayed deposit COD option. If the COD customer is qualified to use the delayed deposit COD option, the registration may be completed and the COD customer may ship one or more packages using the delayed deposit COD option. After a carrier receives a COD package, the carrier will deliver the COD package and collect a COD payment mechanism. If the package was shipped using the delayed deposit COD option, the COD customer may be offered the opportunity to indicate a requested payment deposit date and/or indicate a requested number of days to delay the deposit of the COD payment mechanism. The carrier may then facilitate the deposit of the COD payment mechanism on the indicated payment deposit date. In various embodiments, COD customers depositing checks via the delayed deposit COD option or who maintain a COD customer profile, may be provided with a reduction of bank or other fees associated with check processing. Architectures that may be used in various embodiments of the present invention will now be discussed in more detail herein.

### III. SYSTEM ARCHITECTURE

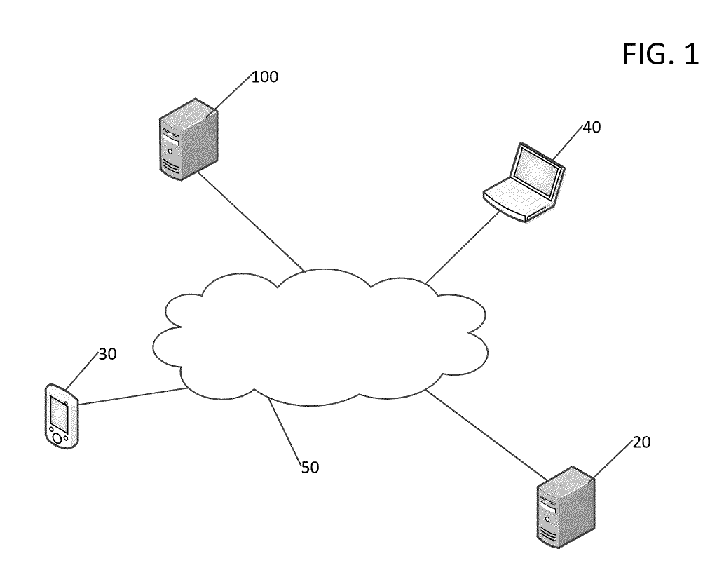

FIG. 1 illustrates an example embodiment of a system architecture that may be used in conjunction with various embodiments of a delayed deposit COD option. The embodiment illustrated in FIG. 1 includes one or more bank systems 20, one or more customer computing devices 40, one or more carrier systems 100, one or more mobile stations 30, and one or more networks 50. Each of these components may be in direct or indirect communication with, for example, one another over the same or different wired or wireless networks 50. Additionally, although the system entities can be separate, standalone entities, the various embodiments are not limited to this particular architecture.

### 1. Carrier System 100

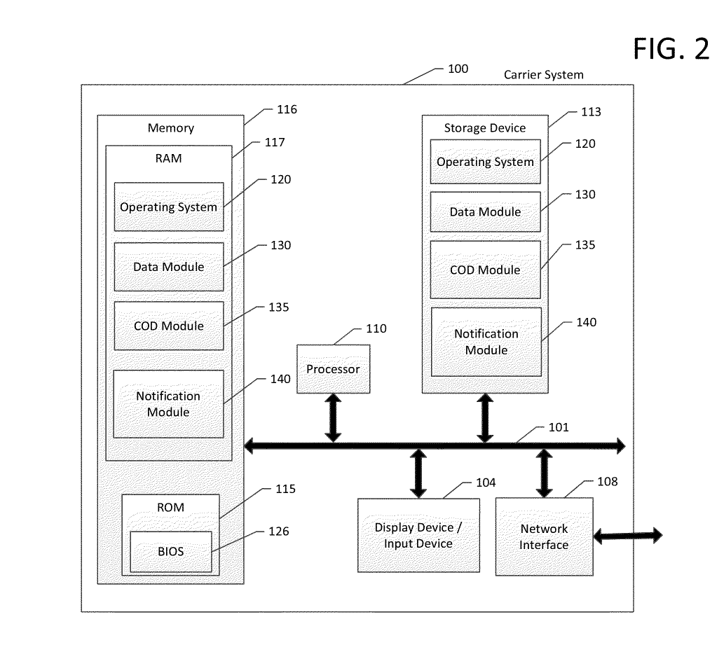

A carrier may be any entity that can carry out or facilitate the transportation and/or delivery of packages. To assist in the transportation and/or delivery of packages, one or more carrier systems may be used. FIG. 2 shows a schematic diagram of an example carrier system 100. In general, the term system may refer to, for example, one or more computers, computing devices, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the carrier system 100 may also include one or more communications interfaces for communicating with various computing entities, such as by communicating data, content, information, and/or similar terms used herein interchangeably that can be transmitted, received, operated on, processed, displayed, stored, and/or the like. For instance, the carrier system 100 may communicate with customer computing devices 40.

In one embodiment, the carrier system 100 may include or be in communication with one or more processing elements 110 (also referred to as processors, processing circuitry, and/or similar terms used herein interchangeably) that communicate with other elements within the carrier system 100 via a bus 101, for example. As will be understood, the processing element 110 may be embodied in a number of different ways. For example, the processing element may be embodied as one or more complex programmable logic devices (CPLDs), microprocessors, multi-core processors, coprocessing entities, application-specific instruction-set processors (ASIPs), and/or controllers. Further, the processing element 110 may be embodied as one or more other processing devices or circuitry. The term circuitry may refer to an entirely hardware embodiment or a combination of hardware and computer program products. Thus, the processing element 110 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 110 may be configured for a particular use or configured to execute instructions stored in volatile or non-volatile media or otherwise accessible to the processing element. As such, whether configured by hardware or computer program products, or by a combination thereof, the processing element 110 may be capable of performing steps or operations according to embodiments of the present invention when configured accordingly.

In one embodiment, the carrier system 100 may further include memory or be in communication with memory 116, which may comprise non-volatile media (also referred to as non-volatile storage, memory, memory storage, memory circuitry and/or similar terms used herein interchangeably). In one embodiment, the non-volatile storage or memory 116 may include one or more non-volatile storage or memory media as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. For example, the non-volatile storage or memory may store code including data module 130, COD module 135, and/or notification module 140. The term database, database instance, database management system, and/or similar terms used herein interchangeably may refer to a structured collection of records or data that is stored in a computer-readable storage medium, such as via a relational database, hierarchical database, and/or network database.

In one embodiment, the memory 116 may further comprise volatile media (also referred to as volatile storage, memory, memory storage, memory circuitry and/or similar terms used herein interchangeably). In one embodiment, the volatile storage or memory may also include one or more volatile storage or memory media as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element. Thus, the databases, database instances, database management systems, data, applications, programs, program modules, scripts, source code, object code, byte code, compiled code, interpreted code, machine code, executable instructions, and/or the like may be used to control certain aspects of the operation of the carrier system 100 with the assistance of the processing element 110 and operating system 120.

In various embodiments, memory 116 can be considered primary memory such as RAM memory or other forms which retain the contents only during operation, or it may be a non-volatile memory, such as ROM, EPROM, EEPROM, FLASH, or other types of memory that retain the memory contents. In some embodiments, the disk storage may communicate with the processor 110 using an I/O bus instead of a dedicated bus. The memory 116 could also be secondary memory, such as disk storage, that stores a relatively large amount of data. The secondary memory may be a floppy disk, hard disk, compact disk, DVD, or any other type of mass storage type known to those skilled in the computer arts. The memory 116 may also comprise any application program interface, system, libraries and any other data by the processor to carry out its functions. ROM 115 is used to store a basic input/output system 126 (BIOS), containing the basic routines that help to transfer information between components of the carrier system 100, including the data module 130, the COD module 135, the notification module 140 and/or the operating system 120.

In addition, the carrier system 100 includes at least one storage device 113, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 113 is connected to the system bus 101 by an appropriate interface. It is important to note that the computer-readable media described above could be replaced by any other type of computer-readable media known in the art. Such media include, for example, memory sticks (e.g., USB memories), magnetic cassettes, flash memory cards, digital video disks, and Bernoulli cartridges.

A number of program modules may be stored by the various storage devices and within RAM 117. Such program modules include the operating system 120, the data module 130, the COD module 135 and/or the notification module 140. Those skilled in the art will appreciate that other modules may be present in RAM 117 to effectuate the various embodiments of the present invention. Furthermore, rather than program modules, the data module 130, the COD module 135, and/or notification module 140 may comprise stand-alone computers connectively coupled to the carrier system 100.

Also located within the carrier system 100 is a network interface 108, for interfacing and communicating with other elements of a computer network, such as by communicating data, content, information, and/or similar terms used herein interchangeably that can be transmitted, received, operated on, processed, displayed, stored, and/or the like. For instance, the carrier system 100 may be in communication with one or more bank systems 20, one or more mobile stations 30, and/or one or more customer computing devices 40. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the route planning server 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA20001X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Various information is input by a user to the carrier system 100 via the network interface 108 and/or input/output device 104. This input information may include information related to packages to be delivered, information related to the delayed deposit of COD payment mechanisms, or other information. This input information may vary, however, depending on the configuration and informational requirements of the carrier system 100.

As mentioned above, the carrier system 100 also includes an input/output device 104 for receiving and displaying data. The carrier system 100 may include or be in communication with one or more input elements, such as a keyboard input, a mouse input, a touch screen/display input, audio input, pointing device input, joystick input, keypad input, and/or the like, as indicated by input/output device 104. The carrier system 100 may also include or be in communication with one or more output elements, as indicated by input/output device 104, such as audio output, video output, screen/display output, motion output, movement output, and/or the like.

The carrier system 100 is configured to facilitate delivery of COD packages and collection and deposit of COD payment mechanisms. The carrier system 100 may be further configured to calculate a payment deposit date based on input from a COD customer, possibly via a customer computing device 40, and facilitate deposit of the COD payment mechanism on the payment deposit date. Additionally, the carrier system 100 may be configured to check and/or request a check to determine if a COD customer is qualified for the delayed deposit COD option, register a COD customer to use the delayed deposit COD option, and/or provide the COD customer with access to a delayed deposit website. The carrier system 100 may be configured to be in communication with one or more bank systems 20, one or more mobile stations 30, and/or one or more customer computing devices 40.

The carrier system 100 may also comprise various other systems, such as an Address Matching System (AMS), an Internet Membership System (IMS), a Customer Profile System (CPS), a Package Center Information System (PCIS), a Customized Pickup and Delivery System (CPAD), a Web Content Management System (WCMS), a Notification Email System (NES), a Fraud Prevention System (FPS), and a variety of other systems and their corresponding components.

Those skilled in the art will recognize that many other alternatives and architectures are possible and can be used to practice various embodiments of the invention. The embodiment illustrated in FIG. 2 can be modified in different ways or incorporated within a network and be within the scope of the invention. For example, one or more components of the carrier system 100 may be located remotely from other carrier system 100 components, such as in a distributed system. Furthermore, one or more of the components may be combined and additional components performing functions described herein may be included in the carrier system 100. Thus, the carrier system 100 can be adapted to accommodate a variety of needs and circumstances.

### 2. Customer Computing Device 40

A customer (e.g., consignor, consignee, shipper, receiver) may be an individual, a family, a company, an organization, an entity, a department within an organization, a representative of an organization and/or person, and/or the like. A customer may be a COD customer. A customer may operate a customer computing device 40 that includes one or more components that are functionally similar to those of the carrier system 100. For example, in one embodiment, each customer computing device 40 may include one or more processing elements, one or more display device/input devices, volatile and non-volatile storage or memory, and/or one or more communications interfaces. These architectures are provided for exemplary purposes only and are not limiting to the various embodiments. Further, the term computing device may refer to one or more computers, computing devices, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions described herein.

### 3. Bank System 20

A bank is an entity, organization, or the like that may be affiliated with a carrier or may be distinct from the carrier. A bank system 20 may include one or more components that are functionally similar to those of the carrier system 100. For example, in one embodiment, the bank system 20 may include one or more processing elements, one or more display device/input devices, volatile and non-volatile storage or memory, and/or one or more communications interfaces. A bank system 20 may further include one or more elements configured for imaging a COD payment mechanism. For example, if a COD payment mechanism is a paper check, the bank system 20 may comprise or be in communication with a scanner, digital camera, and/or the like. A bank system 20 is configured to reconcile COD payment mechanisms with the corresponding payment and package data and/or to deposit a COD payment mechanism on a payment deposit date. Such bank systems 20 may be in communication with one or more carrier systems 100, one or more customer computing devices 40, and/or one or more mobile stations 30.

### 4. Mobile Station 30

Mobile stations 30 can be operated by various parties, including carrier personnel such as delivery drivers, sorters, and/or the like. The mobile station 30 can include an antenna, a transmitter (e.g., radio), a receiver (e.g., radio), and a processing element (such as those described above with regard to the carrier system 100) that provides signals to and receives signals from the transmitter and receiver, respectively.

The signals provided to and received from the transmitter and the receiver, respectively, may include signaling information in accordance with an air interface standard of applicable wireless systems. In this regard, the mobile station 30 may be capable of operating with one or more air interface standards, communication protocols, modulation types, and access types. More particularly, the mobile station 30 may operate in accordance with any of a number of wireless communication standards and protocols, such as those described above with regard to the bank system 20. In a particular embodiment, the mobile station 30 may operate in accordance with multiple wireless communication standards and protocols, such as UMTS, CDMA2000, 1xRTT, WCDMA, TD-SCDMA, LTE, E-UTRAN, EVDO, HSPA, HSDPA, Wi-Fi, WiMAX, UWB, IR, Bluetooth™, USB, and/or the like.

Via these communication standards and protocols, the mobile station 30 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The mobile station 30 can also download changes, add-ons, and updates, for instance, to its firmware, software (e.g., including executable instructions, applications, program modules), and operating system.

According to one embodiment, the mobile station 30 may include a location determining device and/or functionality. For example, the mobile station may include a Global Positioning System (GPS) module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile station 30 may also comprise a user interface (that can include a display coupled to a processing element) and/or a user input interface (coupled to a processing element). The user input interface can comprise any of a number of devices allowing the mobile station to receive data, such as a keypad (hard or soft), a touch display, voice or motion interfaces, or other input device. In embodiments including a keypad, the keypad can include (or cause display of) the conventional numeric (0-9) and related keys (#, *), and other keys used for operating the mobile station and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile station 30 can also include volatile storage or memory and/or non-volatile storage or memory, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the mobile station.

A mobile station 30 may be configured to be in communication with one or more carrier systems 100, one or more bank systems 20, and/or one or more customer computing devices 40. The mobile station 30 may be configured to receive input from a user, such as a delivery vehicle driver, sorter, etc. and store and/or transmit the input to the carrier system 100, the bank system 20, and/or the like. For example, when a delivery vehicle driver delivers a COD package and collects a COD payment mechanism, the mobile station may receive input such as payment data related to the COD payment mechanism and/or package data related to the COD package entered by the delivery vehicle driver via a keyboard, touch screen, optical scanner, and/or other input mechanism.

### IV. SYSTEM OPERATION

As indicated above, various embodiments of the carrier system 100 operate various modules (e.g., modules 130, 135, and 140) to provide one or more COD customers with the delayed deposit COD option. Various embodiments may comprise a data module 130 configured to check if a COD customer is qualified to use the delayed deposit COD option, register a COD customer to use the delayed deposit COD option, and/or maintain a COD customer profile and shipping history information. Various embodiments may comprise a COD module 135 configured to maintain a delayed deposit website that may be used by a COD customer to view pending and/or completed COD package deliveries and/or payments. In various embodiments, the COD module 135 may be configured to facilitate the deposit of a COD payment mechanism to a COD customer's bank account on the requested payment deposit date. Various embodiments may comprise a notification module 140 configured to notify COD customers of pending COD payments, provide reports to the carrier, provide alerts to the carrier and/or COD customer, and/or the like. As should be appreciated, various embodiments may combine the functionality of one or more of the modules 130, 135, and/or 140 or may substitute one or more modules 130, 135, and/or 140 for other methods to incorporate the functionality described herein with respect to modules 130, 135, and/or 140.

### 1. Data Module 130

In various embodiments, the data module 130 may be configured to maintain a customer profile for each of one or more COD customers, check or request a check to determine if a COD customer is qualified to use the delayed deposit COD option, and/or register a COD customer to use the delayed deposit COD option. The various functions that may be performed by the data module 130, according to various embodiments, will now be discussed in detail herein.

In various embodiments, the data module 130 maintains a customer profile for each of one or more COD customers. In various embodiments, a customer profile may comprise identifying information for the COD customer such as a the name of the COD customer, a carrier assigned customer identification number, a contact name, number, physical address, and/or electronic mail address associated with the COD customer, one or more mailing, pick-up, and/or delivery addresses associated with the COD customer. A customer profile may further comprise bank account data, such as one or more bank account numbers associated with the COD customer and/or other bank account data. If a customer profile comprises bank account data, the associated COD customer may be a direct deposit COD customer; thus, the carrier may facilitate direct deposit of funds represented by COD payment mechanisms into a bank account associated with the direct deposit COD customer. In various embodiments, a customer profile may comprise preference data, such as customer notification preferences, payment deposit preferences, shipping preferences, and/or the like. The customer profile may further comprise a shipping history for the COD customer.

The data module 130 may also maintain criteria for determining if a COD customer is qualified to use the delayed deposit COD option. For example, the data module 130 may maintain various thresholds such as length of COD shipping history, annual dollar COD remittances, number of COD tags, and/or the like. In various embodiments, the criteria maintained for determining if a COD customer is qualified to use the delayed deposit COD option may be periodically, regularly, or occasionally updated or reviewed by the carrier.

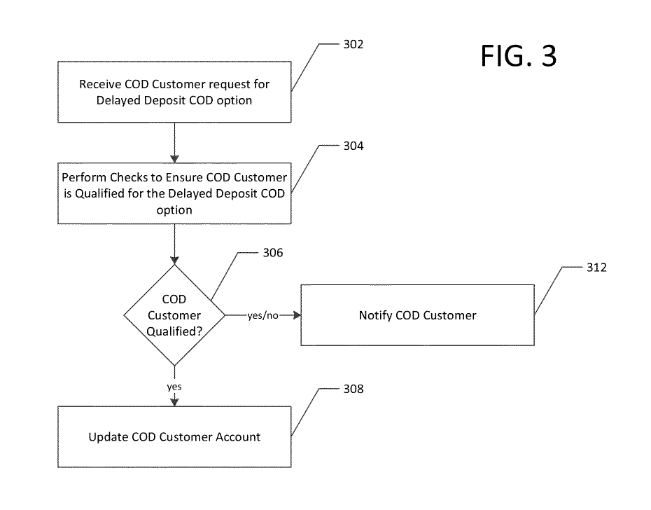

In various embodiments, a carrier system 100 may receive a request from a COD customer to register for the delayed deposit COD option. FIG. 3 illustrates an example registration process that may be initiated by the receipt of a request from a COD customer to register for the delayed deposit COD option. At step 302, a request to register for the delayed deposit COD option is received, possibly by the carrier system 100. In various embodiments, the request may originate from a customer computing device 40. In some embodiments, the COD customer may ask a carrier personnel member to initiate the request such as via a mobile station 30 or a carrier system 100.

At step 304, checks may be conducted to determine if the COD customer is qualified to use the delayed deposit COD option. For example, in various embodiments, a COD customer may need to be an existing COD customer or direct deposit COD customer to qualify to use the delayed deposit COD option. In some such embodiments, the COD customer may need to have been an existing direct deposit COD customer for at least three months to qualify to use the delayed deposit COD option. In various embodiments, the COD customer may need to maintain a daily pick-up account to qualify to use the delayed deposit COD option. In some embodiments, the COD customer may need to meet established thresholds for annual dollar COD remittances and/or number of COD tags. Various other criteria may be combined with the criteria listed herein or in place of the criteria listed herein to determine if a COD customer qualifies to use the delayed deposit COD option. In various embodiments, the data module 130 may be responsible for maintaining the COD customer shipping history information and/or the established threshold information used to determine if a COD customer is qualified to use the delayed deposit COD option.

In various embodiments, a COD customer may be vetted by the carrier's legal department to determine if the COD customer is qualified to use the delayed deposit COD option. For example, if the COD customer is a pharmaceutical company the COD customer may be vetted by the carrier's legal department or by external legal counsel.

In various embodiments, further checks may be used to determine if the COD customer is qualified to use the delayed deposit COD option. In some such embodiments, external checks may be used. For example, the COD customer information may be compared to the United States Excluded Parties Listing to determine if the COD customer is on the United States Excluded Parties Listing or not. If the COD customer is on the United States Excluded Parties Listing, the COD customer may not qualify to use the delayed deposit COD option. In some such embodiments, the COD customer's tax identification number is used to determine if the COD customer is listed on the United States Excluded Parties Listing or not. In some such embodiments, the request to register for the delayed deposit COD option may comprise the COD customer tax identification number. In other such embodiments, in response to the request for registration, the COD customer may be notified, possibly via notification module 140 operating on the carrier system 100, that the COD customer's tax identification number is required to complete the registration process and/or to determine if the COD customer is qualified to use the delayed deposit COD option. In other embodiments, the COD customer tax identification number may be stored in association with the COD customer's customer profile.

At step 306, it is determined whether the COD customer qualifies to use the delayed deposit COD option. At step 312, the COD customer may be notified, possibly via the notification module 140 operating on the carrier system 100, whether the COD customer qualifies to use the delayed deposit COD option. In some embodiments, the COD customer may be notified only if the COD customer does not qualify to use the delayed deposit COD option. In various embodiments, if the COD customer does not qualify to use the delayed deposit COD option, the notification may provide the COD customer with the reasons why the COD customer does not qualify. In various embodiments, if the COD customer does qualify to use the delayed deposit COD option, the notification may provide instructions for completing one or more of the remaining registration steps.

At step 308, if the COD customer qualifies to use the delayed deposit COD option, the customer profile for the COD customer is updated to include information related to the delayed deposit option. For example, the customer profile may be updated to include a bank account number configured to indicate that the COD customer may use the delayed deposit COD option. The customer profile may be updated to include a default deposit parameter which may be used to indicate a default number of days between the delivery of a COD package and the deposit of the COD payment mechanism. In various embodiments, the default deposit parameter may be received by the data module 130 via input originating at a customer computing device 40, a mobile station 30, a carrier system 100, and/or the like. In various embodiments, the carrier may provide a range of acceptable default deposit parameters. In various embodiments, the default deposit parameter is between 1 and 90 days. For example, if the default deposit parameter is 1 day, a COD payment mechanism may be deposited with a default delay of 1 day after the COD package is delivered. If the default deposit parameter is 90 days, a COD payment mechanism may be deposited with a default delay of 90 days after the COD package is delivered. In another embodiment, the default deposit parameter may be between 5 and 150 days, or some other range days. The customer profile may be updated to include other data that may be relevant to the COD customer's use of the delayed deposit COD option.

Once the registration process is complete the COD customer may ship one or more COD packages using the delayed deposit COD option. The processing of a COD package shipped using the delayed deposit COD option and the processing of the corresponding COD payment mechanism may be completed at least in part by the COD module 135, in various embodiments. In various embodiments, the COD customer profile may indicate that the carrier system 100 should automatically facilitate attempt of a declined payment mechanism for a COD customer based on a representation payment parameter. The representation payment parameter may be equal to the delayed deposit payment parameter or may be different form the delayed deposit payment parameter. In various embodiments, the COD customer profile may indicate that a COD customer is to be charged reduced fees for payment mechanism processing.

### 2. COD Module 135

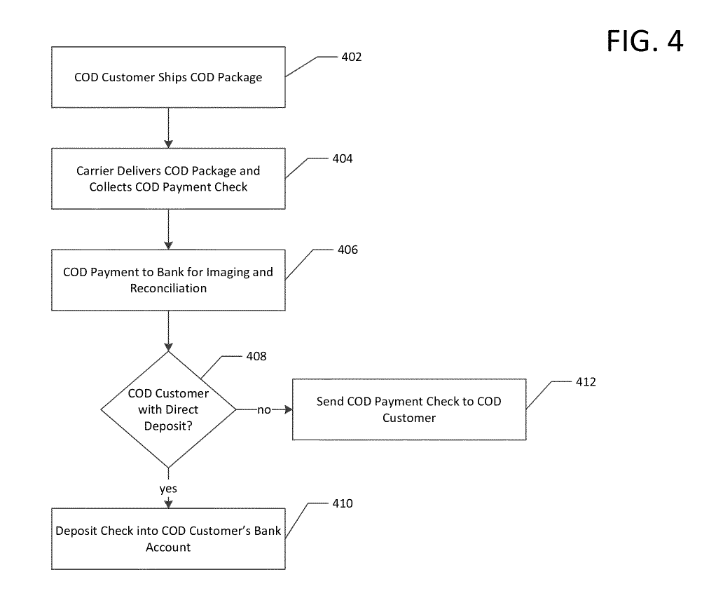

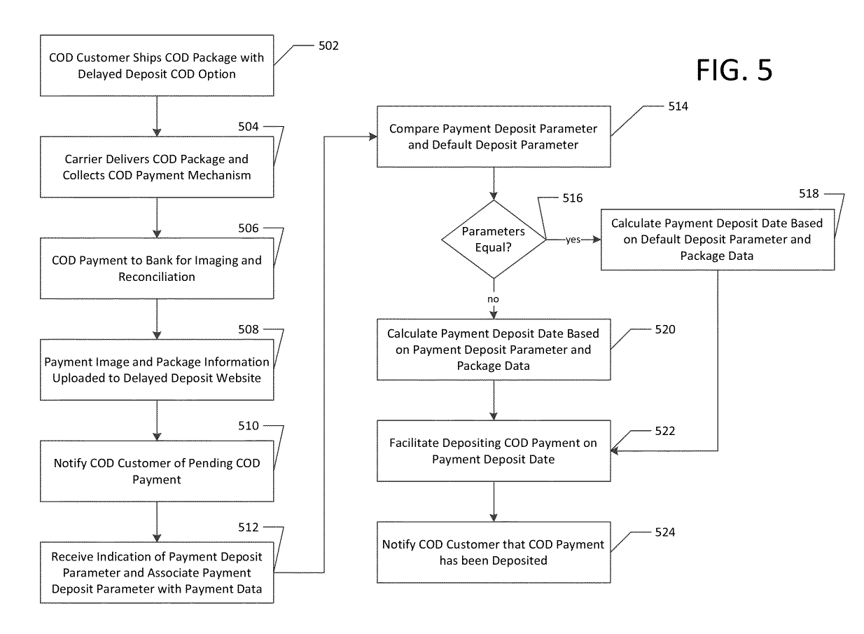

In various embodiments, the COD module 135 is configured to process one or more COD packages shipped using the delayed deposit COD option and the corresponding COD payment mechanism. FIG. 4 illustrates how a COD package shipped without using the delayed deposit COD option and the corresponding COD payment mechanism may be processed. Thus, FIG. 4 provides a contrast to FIG. 5 which illustrates how a package shipped using the delayed deposit COD option and the corresponding COD payment mechanism may be processed according to various embodiments. We begin herein by discussing FIG. 4.

At step 402, a COD customer ships a COD package without using the delayed deposit COD option. At step 404, the carrier delivers the COD package and collects a COD payment mechanism, such as a paper or electronic check or the like. The collected COD payment mechanism is sent to the bank to be imaged and reconciled at step 406. At step 408, it is determined whether the COD customer is a direct deposit COD customer. If the COD customer is not a direct deposit COD customer, the collected COD payment mechanism is sent to the COD customer at step 412. The COD customer will receive the COD payment mechanism and will be responsible for depositing the COD payment mechanism. If the COD customer is a direct deposit COD customer, the collected COD payment mechanism will be deposited into the customer's bank account without delay. Thus, if the delayed deposit COD option is not used to ship a COD package either the COD customer has no flexibility about when the COD payment mechanism is deposited or the COD customer is responsible for facilitating the deposit of the COD payment mechanism.

FIG. 5 illustrates one embodiment of the delayed deposit COD option, which offers a COD customer with an automated, flexible delayed deposit of a COD payment mechanism. At step 502, a COD customer registered to use the delayed deposit COD option ships one or more COD packages using the delayed deposit COD option. In various embodiments, the COD customer's actions to complete step 502 are similar to the COD customer's actions to complete step 402 with the addition of selecting the delayed deposit COD option.

At step 504, the carrier delivers the COD package and collects the COD payment mechanism. In various embodiments, the actions of the carrier to complete step 504 are similar to the carrier's actions to complete step 404. For example, when the delivery vehicle driver delivers the COD package, the driver may input package data related to the COD package and/or delivery of the COD package via a mobile station 30. Additionally, when the delivery vehicle driver collects the COD payment mechanism, the driver may input payment data related to the COD payment mechanism via a mobile station 30.

Similar to step 406, the COD payment mechanism is sent to the bank for imaging and reconciliation at step 506. In various embodiments, the COD payment mechanism may be reconciled against package and/or payment data input by the delivery vehicle driver via the mobile station 30 at step 504. In other embodiments, the COD payment mechanism may be reconciled against package and/or payment data provided via some other input. If the funds represented by the COD payment mechanism are insufficient to pay for the COD shipment, the carrier may decide to adjust the reconciliation.

Once the COD payment mechanism is imaged, the bank system 20 may transmit the electronic image of the COD payment mechanism, and possibly other payment and/or package data, to the carrier system 100. The COD module 135 operating on the carrier system 100 may upload the payment and/or package data to a delayed deposit website, at step 508. Particularly, the electronic image of the COD payment mechanism may be uploaded to the delayed deposit website at step 508.

At step 510, the COD customer is notified of the pending COD payment, possibly via the notification module 140 operating on carrier system 100. In response to the notification that a COD payment is pending, the COD customer may choose to log on to the delayed deposit website to view payment and/or package data related to the pending COD payment.

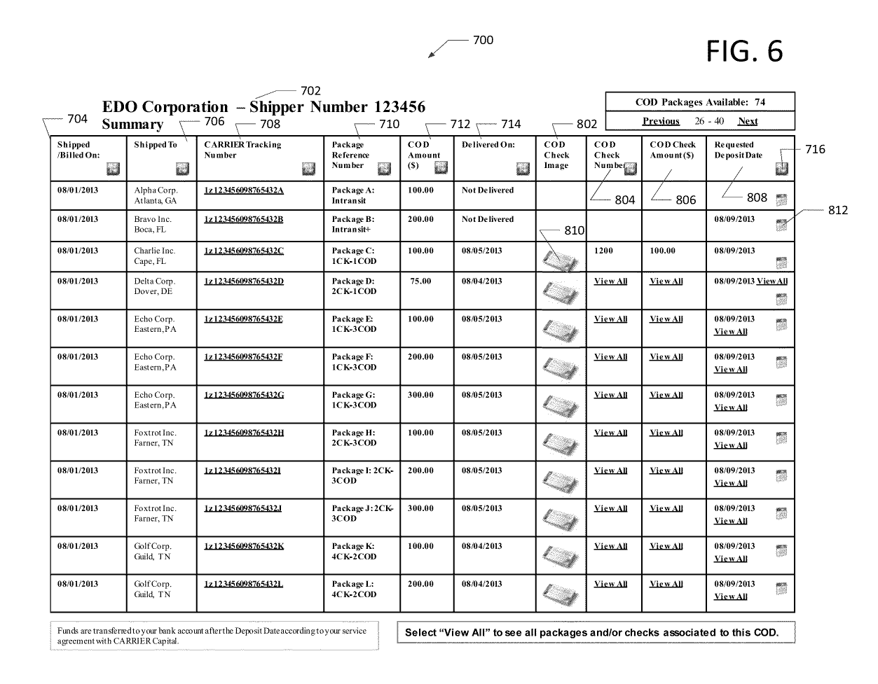

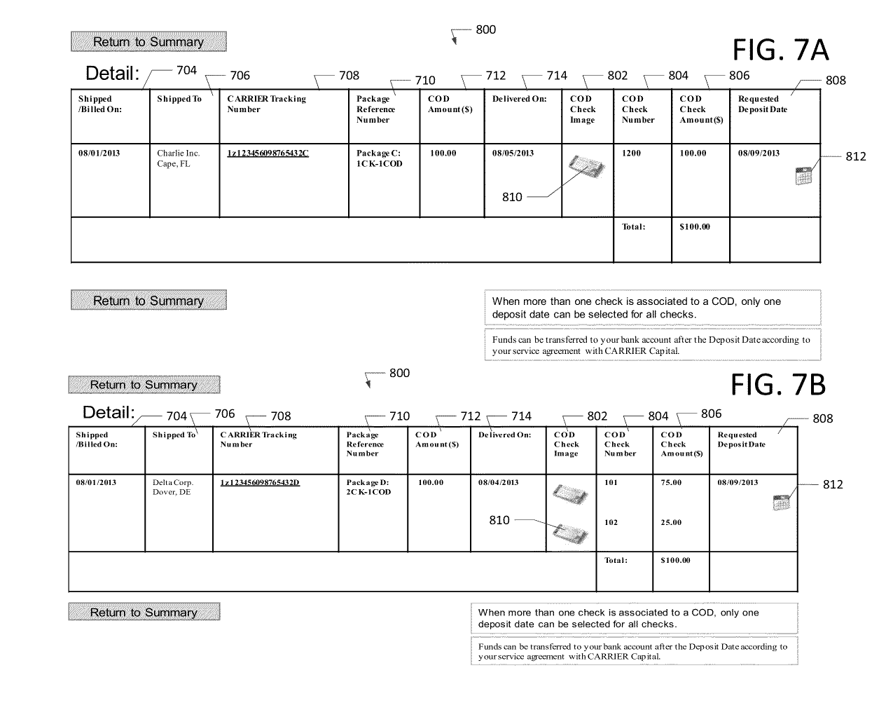

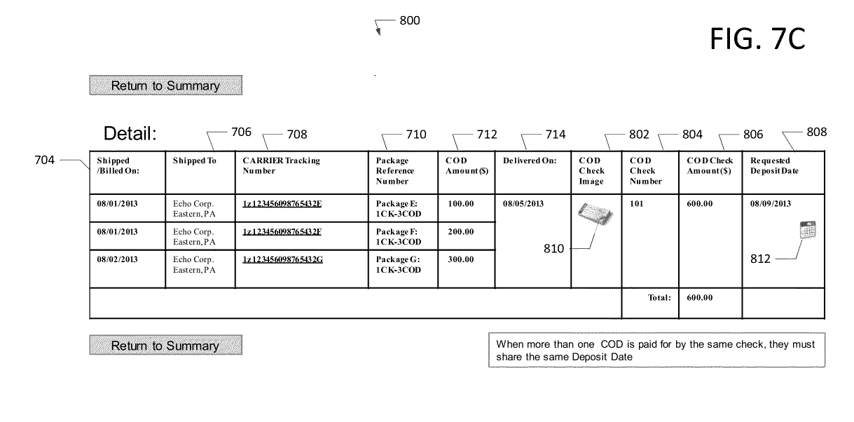

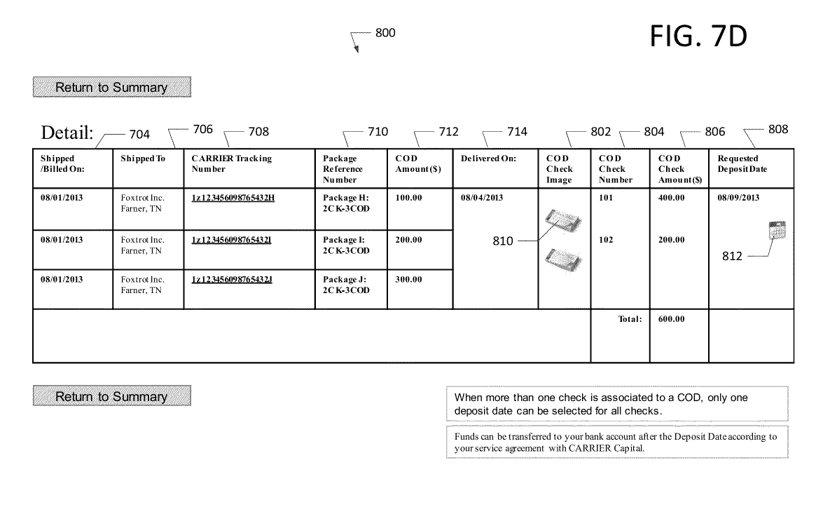

In various embodiments, the COD module 135 is configured to maintain the delayed deposit website and/or provide one or more COD customers access to the delayed deposit website. FIGS. 6, 7A, 7B, 7C, and 7D show screen shots of an exemplary delayed deposit website that is provided in conjunction with various embodiments of the systems described elsewhere herein. The screen shots illustrated in FIGS. 6 and 7A-7D are meant to illustrate the organization and information that may be displayed on a possible delayed deposit website, rather than to be limiting.

FIG. 6 shows an example summary window 700 of a delayed deposit website. The summary window 700 may display various package and/or payment data associated with all or a subset of the COD packages shipped by the COD customer. The summary window 700 may include information identifying the COD customer that shipped the list COD packages. For example, the summary window 700 may include the shipper identification number 702. The summary window 700 may also include package and/or payment data for all or a subset of COD packages shipped by the COD customer. For each COD package, the summary window 700 may include a plurality of columns listing package data such as a shipped/billed on date column 704, a shipped to column 706, a carrier tracking number column 708, a package reference number column 710, a COD amount column 712, and/or a delivered on column 714, indicating the date on which the COD package was delivered. The summary window 700 may also include a plurality of columns listing payment data such as a COD check image column 802, a COD check number column 804, a COD check amount column 806, and/or a requested deposit date column 808. In various embodiments, other package and/or payment data may be displayed on the summary window 700 in place of or in addition to that shown in FIG. 6. In other embodiments, the summary window 700 may display less package and/or payment data than shown in FIG. 6 and/or be organized in a different manner.

The summary window 700 may also include various tools that a user (e.g., a COD customer) viewing the summary window my use to navigate the listing of COD packages. For example, the summary window 700 may also include sorting buttons 716, which a user may use to sort the listed COD packages based on a column of the user's choice. In some embodiments, the summary window 700 may include one or more COD payment mechanism view buttons, such as check view button 810. In various embodiments, a user may select the check view button 810 to view an image of the COD payment mechanism, such as an electronic image of a paper check, an electronic rendering of an electronic check, or the like.

Additionally, in some embodiments, the summary window 700 may include one or more calendar buttons 812 that a user may select to view a calendar. In various embodiments, the user may select a date on the calendar to indicate a requested deposit date for a particular COD payment mechanism. In some embodiments, the user may select the appropriate row in the requested deposit date column and type in or otherwise enter a requested deposit date. The carrier may dictate a range of days that may be selected as the requested deposit date. For example, in various embodiments, the requested deposit date is no less than one and no more than 90 days after the COD package delivery date. In other embodiments, the user may select the appropriate row and enter a payment deposit parameter indicating a requested number of days between the delivery day and the payment deposit date. To enter the payment deposit parameter, the user may type in a number, or select a number in some other manner, such as selecting a number from a list. In various embodiments, the payment deposit parameter is no less than one day and no more than 90 days.

In various embodiments, a user viewing the summary window 700 may choose to view a detail window 800 which may display details related to one or more COD packages. In various embodiments, the user may select “view all” in the COD check number column 804, COD check amount column 806, or requested deposit date column 808 in the row corresponding to the COD package of interest in order to view the detail window 800 corresponding to that COD package. A variety of other methods and mechanisms may be implemented to allow a user to select a COD package of interest in order to view the detail window 800 corresponding to that COD package, such as selecting the package reference number or the like.

FIG. 7A shows a detail window 800 that may be displayed if the user selects the third package listed on summary window 700. In the embodiment shown in FIG. 7A, the detail window 800 lists package and payment data such as a shipped/billed on date column 704, a shipped to column 706, a carrier tracking number column 708, a package reference number column 710, a COD amount column 712, a delivered on column 714, a COD check image column 802, a COD check number column 804, a COD check amount column 806, and a requested deposit date column 808. In various embodiments, other package and/or payment data may be displayed on the detail window 800 in place of or in addition to that shown in FIG. 7A. In other embodiments, the detail window 800 may display less package and/or payment data than shown in FIG. 7A and/or be organized in a different manner. While viewing detail window 800, a user may choose to view an electronic image of the COD payment mechanism. In the embodiment shown in FIG. 7A, the user may select the check view button 810 to view an electronic image of the COD payment mechanism. In various embodiments, the detail window may also include a calendar button 812 which a user may select in order to view a calendar and/or indicate a requested payment deposit date. As noted above, in various embodiments, the user may indicate a requested payment deposit date or a payment deposit parameter using a variety of methods and/or mechanisms.

FIG. 7A illustrates an example detail window 800 for a COD package in which one COD package is associated with one COD payment mechanism. However, it is possible that more than one COD package may be associated with a single COD payment mechanism, one COD package may be associated with more than one COD payment mechanism, or that more than one COD package may be associated with more than one COD payment mechanism. FIGS. 7B, 7C, and 7D illustrate example detail windows 800 for instances when there is not a one-to-one connection between a single COD package and a single COD payment mechanism. FIG. 7B illustrates an example detail window 800 for a case where one COD package is associated with two COD payment mechanisms. FIG. 7C illustrates an example detail window 800 for a case where three COD packages are associated with a single COD payment mechanism. FIG. 7D illustrates an example detail window 800 for a scenario where three COD packages are associated with two COD payment mechanisms. In various embodiments, if more than one COD payment mechanism is associated with one or more COD packages, all of the COD payment mechanisms associated with those one or more COD packages may be assigned the same payment deposit date.

Returning to FIG. 5, the COD module 135 operating on the carrier system 100 may receive an indication of a payment deposit parameter and associate the payment deposit parameter with the payment data at step 512. In various embodiments, the COD module 135 receives the indication of the payment deposit parameter by a COD customer logging onto the delayed deposit website and entering or selecting a requested deposit date or payment deposit parameter on a summary window 700, a detail window 800, or on some other window associated with the delayed deposit website. In other embodiments, a COD customer may respond to a notification that a COD payment is pending and indicate a payment deposit parameter and/or requested deposit date via email, text message, a phone call, or some other method or mechanism. If the COD customer indicates a requested deposit date, the COD module 135 may calculate the corresponding payment deposit parameter by counting the number of days between the delivery date and the requested deposit date, or by some other algorithm. In some embodiments, a COD customer may indicate a payment deposit parameter by not providing an affirmative indication of a payment deposit parameter or requested deposit date within a predetermined time period. For example, in some embodiments, if a COD customer does not provide an affirmative indication of a payment deposit parameter or requested deposit date within three hours of being notified that the COD payment is pending, the COD module 135 may set the payment deposit parameter equal to the default deposit parameter associated with the COD customer's customer profile. In other embodiments, if a COD customer does not provide an affirmative indication of a payment deposit parameter or requested deposit date within two days, one week, or one month of being notified that the COD payment is pending, the COD module 135 may set the payment deposit parameter equal to the default deposit parameter associated with the COD customer's customer profile. In various embodiments, the time period within which a COD customer is expected to respond to a notification that a COD payment is pending may depend on the default deposit parameter associated with the COD customer's customer profile. For example, if a customer has selected a default deposit parameter of four days, the time period for a COD customer to respond may be two days. If a customer has selected a default deposit parameter of 30 days, the time period for a COD customer to respond may be 28 days. In various embodiments, if the COD customer indicates a requested deposit date or payment deposit parameter that would result in the payment deposit date having already passed, the COD payment mechanism may be deposited as soon as possible, the next day, or in accordance with the default deposit parameter associated with the COD customer's customer profile. As noted above, in various embodiments, the payment deposit parameter is no less than one day and no more than 90 days. Once the indication of the payment deposit parameter is received by the COD module 135, the payment deposit parameter is associated with the payment data associated with the appropriate COD package.

After the indication of the payment deposit parameter is received, or possibly in response to receiving the indication of the payment deposit parameter, the COD module 135 may compare the payment deposit parameter and the default deposit parameter, at step 514. In general, after the comparison of the payment deposit parameter and the default deposit parameter, or possibly in response to the comparison of the payment deposit parameter and the default deposit parameter, the payment deposit date may be calculated. The calculation of the payment deposit date may be based on the comparison of the payment deposit parameter, the default deposit parameter and at least a portion of the package data, such as the delivery date and/or other delivery data, and/or other data.

Particularly, the comparison of the payment deposit parameter and the default deposit parameter may lead to a determination, at step 516, that the payment deposit parameter and the default deposit parameter are the same. In this case, at step 518, the payment deposit date may be calculated based on the default deposit parameter, at least a portion of the package data, such as the delivery date and/or other delivery data, and/or other data. In some scenarios, the comparison of the payment deposit parameter and the default deposit parameter may determine, at step 516, that the two parameters are different or not the same. In these scenarios, the COD module 135 continues to step 520 and calculates the payment deposit date based on the payment deposit parameter, at least a portion of the package data, such as the delivery date and/or other delivery data, and/or other data.

Regardless of whether the payment deposit date is calculated via step 518 or 520, after the payment deposit date is calculated, or possibly in response thereto, the COD module 135 facilitates the deposit of the COD payment mechanism on the calculated payment deposit date, at step 522. In various embodiments, facilitating the deposit of the COD mechanism may comprise notifying the COD customer that the pending COD payment will be deposited on the payment deposit date, possibly via the notification module 140 operating on the carrier system 100. In various embodiments, the COD module 135 is configured receive input from a COD customer indicating that the COD customer approves of the payment deposit date before transmitting the deposit instructions to a bank system 20. In various embodiments, the COD module 135 is configured to transmit the deposit instructions at an appropriate date and time for the COD payment mechanism to be deposited on the payment deposit date. For example, in some embodiments, if the COD customer has not affirmatively provided approval of the payment deposit date before the payment deposit date, the COD module 135 may automatically transmit the deposit instructions to the bank system 20 without receiving approval. In other embodiments, approval of the payment deposit date from the COD customer is not requested and the COD module 135 automatically transmits the deposit instructions on or before the payment deposit date.

In some embodiments, the COD module 135 is configured to facilitate the deposit of the COD payment mechanism on the payment deposit date by compiling and transmitting deposit instructions to the bank system 20. In various embodiments, the deposit instructions may comprise the payment deposit date and at least a portion of the customer profile data, such as the bank account data needed to deposit the funds represented by the COD payment mechanism into the COD customer's bank account. In various embodiments, the deposit instructions are transmitted to the bank system 20 after, or possibly in response to, receiving an indication of a COD customer's approval of the deposit date. The indication of the COD customer's approval of the deposit date may comprise a response to a notification indicating the deposit date, input received via the delayed deposit website, or the lapsing of a predetermined time period without an affirmative response. Similar to the predetermined time period discussed above with respect to the indication of the payment deposit parameter, the predetermined time period may be determined by the carrier, determined by the customer preferences associated with the COD customer's customer profile, and/or may depend on the payment deposit date. In other embodiments, the deposit instructions are automatically transmitted to the bank system 20. In such embodiments, an indication of a COD customer's approval of the deposit date may not be requested and/or may not be necessary. Therefore, deposits of payment mechanisms may be facilitated on a daily, weekly, biweekly, monthly, or other basis.

In various embodiments, after the COD payment mechanism is deposited, the carrier system 100 may receive notification of the deposit from the bank system 20. In some embodiments, at step 524, the carrier system 100, possibly via the notification module 140, may notify the COD customer that the COD payment mechanism has been deposited and that the funds represented by the COD payment mechanism are available via the COD customer's bank account. The COD module 135 may then update the delayed deposit website to indicate that the COD payment mechanism has been deposited. The COD module 135 may also provide package and/or payment data associated with the completed COD package delivery and payment deposit to the data module 130 for association with the COD customer's customer profile and/or shipping history.

In various embodiments, after attempting to deposit the COD payment mechanism, the carrier system 100 may receive notification that insufficient funds were available for depositing the payment mechanism or that some other issue or error occurred, which prevented the deposit of the payment mechanism. In some such embodiments, the carrier system 100, possibly via the notification module 140, may notify or alert the COD customer of the issue which prevented the deposit of the payment mechanism. In some embodiments, the COD customer profile associated with the COD customer may indicate that the COD customer would like a dishonored payment mechanism or other COD payment mechanism that experienced and error during depositing, to be automatically represented to the bank system 20 in accordance with a payment deposit parameter. The re-presentation payment deposit parameter may be the same as the default payment deposit parameter. In some embodiments, the COD customer may be offered the option of providing a re-presentation payment deposit parameter that is different from the default payment deposit parameter. In various embodiments, the carrier system 100 may facilitate the re-presentation of the COD payment mechanism in accordance with the re-presentation payment deposit parameter in a similar manner as described herein for the initial presentation of the COD payment mechanism in accordance with the payment deposit parameter.

### 3. Notification Module 140

In various embodiments, a notification module 140 may be operating on the carrier system 100. In various such embodiments, the notification module 140 may be configured to notify a COD customer of pending and/or deposited COD payments, provide various alerts, and compile COD shipment reports for the carrier. In various embodiments, notifications, alerts, and/or reports may be transmitted or otherwise provided to a COD customer or carrier personnel daily, weekly, monthly, quarterly, annually, and/or the like. In various embodiments, a report may be a scheduled reporting of activity relating to one or more COD payment mechanisms or COD shipments associated with the COD customer including information related to payment data or package data. In various embodiments, a notification may be a scheduled or unscheduled communication providing information to a COD customer or requesting information from a COD customer. In various embodiments, an alert may be an unscheduled communication alerting the COD customer of an error in processing a COD payment mechanism, delivery of a COD shipment, or the like or may provide the COD customer with time sensitive information. In various embodiments, reports, notifications, and alerts may be provided to the COD customer via email, text message, voicemail, a delayed deposit website, and/or the like.

In various embodiments, the notification module 140 may be configured to send notifications to a COD customer, possibly via a customer computing device 40, in response to activity described herein as related to the data module 130. For example, the notification module 140 may notify a COD customer that the COD customer's tax identification number is requested in order to facilitate the checks used to determine if a COD customer is qualified to use the delayed deposit COD option. In some embodiments, the notification module 140 may notify a COD customer that customer input indicating a default deposit parameter is requested. Additionally, in some embodiments, the notification module 140 may be configured to notify a COD customer if they are qualified to use the delayed deposit COD option and/or that the COD customer has completed the registration process and may now use the delayed deposit COD option. In various embodiments, the notification module 140 may be configured to send various notifications to a COD customer on a regular basis, such as daily, weekly, biweekly, monthly, quarterly, annually, as necessary and/or the like. For example, the notification module 140 may provide a COD customer with a daily notification of pending COD deliveries and/or pending delayed COD payments.

In various embodiments, the notification module 140 may be configured to send notifications to a COD customer, possibly via a customer computing device 40, in response to activity described herein as related to the COD module 135. As noted above, in various embodiments, the notification module 140 may notify the COD customer that a COD payment is pending. For example, the notification module 140 may send a notification to a COD customer that a COD payment mechanism has been received. The notification may request that the COD customer respond to indicate a payment deposit parameter and/or requested deposit date, to indicate approval of a payment deposit date, or merely inform the COD customer that the COD payment is pending and that if the COD customer does not respond, the COD payment will be deposited on a particular payment deposit date based on the default deposit parameter. In some embodiments, the COD customer may receive multiple notifications related to the same pending COD payment. For example, a COD customer may be notified that a COD payment is pending and later notified of the payment deposit date. In another example, a COD customer may be provided with advance notice of returned items or scheduled deposits. For example, if a COD customer has elected to receive daily, weekly, biweekly, monthly, quarterly, or other notifications, the notifications may include information regarding scheduled deposits, returned items, and/or the like. In other embodiments, an advance notice of returned items may be provided as an alert. In some embodiments, the notification listing the payment deposit date may request approval of the payment deposit date. In some embodiments, the notification module 140 may notify the COD customer that the COD payment mechanism has been deposited. In various such embodiments, the notification may include the date the COD payment mechanism was deposited, the bank account the funds represented by the COD payment mechanism were deposited into, the COD package(s) to which the COD payment mechanism is associated, and/or the like.

As noted above, the data module 130 may maintain customer notification preferences associated with a COD customer. In such embodiments, the contents of the notification may be determined by customer notification preferences associated with the COD customer. The customer notification preferences may further comprise a preferred notification mechanism, such as a phone number associated with the COD customer, an email address associated with the COD customer, and/or other preferred notification mechanisms. In various embodiments, a COD customer may be notified via email, text message, instant message, phone, voice mail, fax, calendar event invite, or other notification method. The customer notification preferences may further comprise preferences about which notifications a COD customer would like to receive. In some embodiments, the customer notification preferences may indicate the frequency with which a COD customer would like to receive various notifications (e.g., daily, weekly, monthly, quarterly, annually, and/or the like).

In various embodiments, the notification module 140 may also be configured to provide alerts to the COD customer and/or the carrier. For example, if the bank system cannot or might not be able to deposit a COD payment mechanism on a particular date due to a technical issue, a bank holiday, or some other reason, the bank system may notify the carrier system 100. The notification module 140 operating on the carrier system 100 may then provide the COD customer or carrier personnel with an alert that the COD payment mechanism may not be deposited on the particular payment deposit date. Other alerts may be issued by the notification module 140. For example, an alert may be issued if a COD payment mechanism cannot be deposited due to insufficient funds in the originating bank account, an invalid account number is listed as the originating bank account, and/or other issues that may prevent or delay the deposit of the COD payment mechanism.

In various embodiments, the notification module 140 may compile various reports. For example, the notification module 140 may compile package and/or payment data for one or more COD packages shipped by one or more COD customers to create various internal reports. The reports compiled by the notification module 140 may also be used for providing a COD customer with a report related to the COD packages shipped by the COD customer, billing a COD customer for delivery of the COD packages shipped by the COD customer, and trend analysis. In various embodiments, some reports compiled by the notification module 140 may be uploaded to the delayed deposit website for viewing by one or more COD customers as appropriate. In various embodiments, various reports may be compiled, stored in association with a COD customer profile, and/or provided to a COD customer (e.g., via a customer computing device 40) and/or to carrier personnel (e.g., via the carrier system 100) daily, weekly, monthly, quarterly, annually, and/or the like.

In some embodiments, the bank system 20 may transmit COD payment mechanism reconciliation reports which may be received and/or processed by the notification module 140. The COD payment mechanism reconciliation reports may detail the number of COD payment mechanisms received by the bank, the number of COD payment mechanisms reconciled by the bank, and/or the number of shippers for which COD payment mechanisms have been received and/or reconciled by the bank for a particular period of time. In some embodiments, these reports may be compiled with other COD package and/or payment data by the notification module 140 to create other reports.

As described herein, the data module 130, the COD module 135, and the notification module 140 are separate modules operating on the carrier system 100. In various embodiments, the functionality of the modules 130, 135, and/or 140 may be implemented via various methods other than those disclosed herein. For example, in some embodiments, the data module 130 may be responsible for compiling the reports described herein with regard to the notification module 140. In another example, modules 130 and 135 may be combined into a single module and/or may be operate on a computing system separate from and in communication with the carrier system 100. Thus, modules 130, 135, and 140 are described as separate modules herein in order to describe various functions of various embodiments, rather than to be limiting.

### V. CONCLUSION

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for providing a delayed deposit collection on delivery (COD) option to a COD customer, said system comprising:
one or more storage areas containing customer profile data associated with said COD customer, payment data, package data associated with at least one COD package shipped by said COD customer, and parameter data, wherein said parameter data comprises a default deposit parameter associated with said COD customer; and
one or more computer processors configured to:
receive a portion of said payment data and said package data, said portion of said payment data comprising an electronic image of a COD payment mechanism;
receive an indication of a payment deposit parameter;
associate said payment deposit parameter with said payment data;
compare said payment deposit parameter to said default deposit parameter;
calculate a payment deposit date, said calculation being based at least in part on said comparison and at least a portion of said package data comprising delivery data;
in response to said calculation of said payment deposit date, facilitate depositing said COD payment mechanism on said calculated payment deposit date; and
in response to receiving notification of an error occurring during the depositing of said COD payment mechanism, automatically re-present said COD payment mechanism.

2. The system of claim 1 wherein said one or more computer processors are further configured to:
generate a report comprising information associated with at least one of said payment data or said package data; and
provide said report to said COD customer.

3. The system of claim 1 wherein said customer profile data comprises an indication that if the system receives notification of an error occurring during the depositing of said COD payment mechanism COD, said COD payment mechanism is to be automatically re-presented in accordance with a second payment deposit parameter.

4. The system of claim 3 wherein said second payment deposit parameter is equal to said payment deposit parameter.

5. The system of claim 1 wherein the one or more computer processors are further configured to provide the COD customer with advance notice of one or more return items.

6. The system of claim 5 wherein the advance notice is in the form of a report, a notification, or an alert.

7. A computer-implemented method for providing a delayed deposit collection on delivery (COD) shipping option for a COD customer, the method comprising the steps of:
receiving and storing, within one or more memory storage areas, customer profile data associated with said COD customer, payment data, package data associated with at least one COD package shipped by said COD customer, and parameter data, wherein said parameter data comprises a default deposit parameter associated with said COD customer;
receiving a portion of said payment data and said package data, said portion of said payment data comprising an electronic image of a COD payment mechanism;
receiving an indication of a payment deposit parameter;
associating said payment deposit parameter with said payment data;
comparing, via at least one computer processor, said payment deposit parameter to said default deposit parameter;
calculating, via at least one computer processor, a payment deposit date, said calculation being based at least in part on said comparison and at least a portion of said package data comprising delivery data;
in response to said calculation of said payment deposit date, facilitating depositing said COD payment mechanism on said calculated payment deposit date; and
in response to receiving notification of an error occurring during the depositing of said COD payment mechanism, automatically re-presenting said COD payment mechanism.

8. The method of claim 7 further comprising:
generating a report comprising information associated with at least one of said payment data or said package data; and
providing said report to said COD customer.

9. The method of claim 7 wherein if said payment deposit parameter and said default deposit parameter are equal, said calculation of said payment deposit date is based at least in part on said default deposit parameter and at least a portion of said package data comprising delivery data.

10. The method of claim 7 wherein if said payment deposit parameter and said default deposit parameter are not equal, said calculation of said payment deposit date is based at least in part on said payment deposit date and at least a portion of said package data comprising delivery data.

11. The method of claim 7 wherein said customer profile data comprises an indication that if the system receives notification of an error occurring during the depositing of said COD payment mechanism COD, said COD payment mechanism is to be automatically re-presented in accordance with a second payment deposit parameter.

12. The method of claim 11 wherein said second payment deposit parameter is equal to said payment deposit parameter.

13. The method of claim 7 wherein the one or more computer processors are further configured to provide the COD customer with advance notice of one or more return items.

14. The method of claim 13 wherein the advance notice is in the form of a report, a notification, or an alert.

15. A non-transitory computer program product comprising at least one computer-readable storage medium having computer-readable program code portions embodied therein, the computer-readable portions comprising:
(A) an executable portion configured for receiving a plurality of data, wherein said data comprises:
(i) customer profile data associated with a collection on delivery (COD) customer;
(ii) payment data, wherein said payment data comprises an electronic image of a COD payment mechanism;
(iii) package data associated with at least one COD package shipped by said COD customer;
(iv) parameter data, wherein said parameter data comprises a default deposit parameter associated with said COD customer; and
(v) an indication of a payment deposit parameter;
(B) an executable portion configured for comparing said payment deposit parameter to said default deposit parameter;
(C) an executable portion configured for calculating a payment deposit date based at least in part on said comparison and at least a portion of said package data comprising delivery data;
(D) an executable portion configured for, in response to calculating said payment deposit date, generating one or more instructions, said instructions configured to facilitate depositing said COD payment mechanism on said payment deposit date; and
(E) an executable portion configured for, in response to receiving notification of an error occurring during the depositing of said COD payment mechanism, automatically re-present said COD payment mechanism.

16. The computer program product of claim 15 further comprising:
an executable portion configured for generating a report comprising information associated with at least one of said payment data or said package data; and
an executable portion configured for providing said report to said COD customer.

17. The computer program product of claim 15 wherein said customer profile data comprises an indication that if the system receives notification of an error occurring during the depositing of said COD payment mechanism COD, said COD payment mechanism is to be automatically re-presented in accordance with a second payment deposit parameter.

18. The computer program product of claim 17 wherein said second payment deposit parameter is equal to said payment deposit parameter.

19. The computer program product of claim 15 further comprising:
an executable portion configured for providing the COD customer with advance notice of one or more return items.

20. The computer program product of claim 19 wherein the advance notice is in the form of a report, a notification, or an alert.
